(19) United States
(12) Patent Application Publication
(10) Pub. No.: US 2025/0357839 A1
(43) Pub. Date: Nov. 20, 2025

(54) Vibration-Tolerant Conduction Cooling Mechanism for Rotor-Mounted Cryocooler Electrical Machines

(71) Applicant: Hinetics, Inc., Champaign, IL (US)

(72) Inventors: Thanatheepan Balachandran, Savoy, IL (US); Kiruba S. Haran, Champaign, IL (US)

(21) Appl. No.: 19/208,875

(22) Filed: May 15, 2025

Related U.S. Application Data
(60) Provisional application No. 63/648,274, filed on May 16, 2024.

(51) Int. Cl. H02K 55/00; H02K 1/26; H02K 1/28; H02K 9/22

(52) U.S. Cl. CPC H02K 55/00; H02K 1/26; H02K 1/28; H02K 9/22

(57) ABSTRACT

A conduction cooling system mitigates vibration transmission from the rotor to the cold end in rotor-mounted cryocoolers. Utilizing a combination of steady and flexible thermal straps, along with a center ring for balance and force cancellation, this system improves performance of the conduction-cooled mechanism and the cryocooler by isolating them from detrimental vibration and imbalance force effects.

### CROSS REFERENCE TO RELATED APPLICATION

This application claims the benefit of U.S. provisional application 63/648,274, filed May 16, 2024, and hereby incorporated by reference.

### STATEMENT REGARDING FEDERALLY SPONSORED RESEARCH OR DEVELOPMENT

—

### BACKGROUND OF THE INVENTION

### Field of the Invention

The present invention relates to rotor-mounted cryogenic motors and, more specifically, to a system and method to reducing imbalance forces and handling vibration associated with rotor-mounted cryocoolers for conduction cooling.

### Description of Related Art

Electric motors for aerospace applications, for example, for use in aircraft, desirably provide a high specific power, that is high-power output with light weight. Currently produced wound-field synchronous motors can provide about two kilowatts of power per kilogram of weight with a nominal efficiency of about 90 percent. Recent advances using permanent magnets have achieved specific power in excess of 13 kilowatts per kilogram with efficiencies in excess of 96 percent; however, the fault tolerance of such permanent magnet systems has not been established.

Desirably, the permanent magnets of such electric motors could be replaced with superconducting coils to provide improved efficiency and lighter weight (i.e., greater specific power). The substantial demands of cryogenic cooling sufficient to cool such motors, however, present a significant challenge because of the weight, complexity, and bulk of such coolers and the necessary plumbing for fluids used for heat transfer between the motor and the cooler.

US patent application Ser. No. 17/498,294 filed Oct. 11, 2021, and assigned to the assignee of the present invention describes an electric motor design with greatly reduced cooling demands possible by confining the cooling to the rotor (which may be isolated in a rotor-specific vacuum envelope) and minimizing heat transfer between the rotor and the rotor shaft or other structures by suspending the rotor shell on the rotor shaft with high thermal resistance tensile spokes. The resulting reduced heat flow allows direct conductive cooling of the rotor coils using a cryocooler. The cryocooler extends partially into the shaft and includes radially extending conductive straps extending between the rotor shell and the cold end to provide thermal conduction of heat from the coils to the cold end of the cryocooler.

However, the radially extending conductive straps have certain drawbacks. These long thermal links between the shell of the rotor and the cold end can create unbalanced systems and exert additional forces on the cold end during operation. Such vibration and additional forces can degrade the performance of the cryocooler, especially considering the sensitivity of cold ends to vibration and bending. These thermal straps also can transfer torque to the cryocooler, resulting in unwanted damage to the cryocooler. Existing solutions have not adequately addressed these challenges.

Thus, it would be desirable to provide an improved conduction cooling system for cryocooler mounted motors.

### SUMMARY OF THE INVENTION

The present invention provides an improved conduction cooling system for cryocooler mounted motors. The conduction cooling arrangement described herein is designed to effectively isolate a cryocooler from vibration and unbalanced forces present on the thermal straps extending between the rotor shell and the cold end of the cryocooler. The present invention utilizes a combination of rigid and flexible thermal straps for conduction cooling. The conduction cooling arrangement features a unique configuration with rigid thermal straps connected to the rotor shell, and at least one flexible thermal strap for vibration isolation. A first end of each rigid thermal strap is mounted to the rotor shell, and a second end of each rigid thermal strap is mounted to a center ring, providing balance and canceling out centrifugal forces. This configuration ensures that the weights of the thermal straps are self-supported and not transferred to the cold end. Additionally, the cryocooler is supported on the shaft, and at least one flexible thermal strap connects a cold end adapter to the center ring. The flexible thermal strap(s) mitigate any axial misalignment of the rigid thermal straps and center ring such that the misalignment does not affect the alignment of the cold end. The flexible strap(s) also does not transfer vibration or torque ripple effects coming from rotor shell to the cold end.

According to one embodiment of the invention, a motor includes a stator and a rotor, where the rotor includes an outer shell, a central shaft mounted within the outer shell, a set of coils mounted on the outer shell, and a cryocooler mounted within the central shaft. The outer shell and the central shaft rotate in tandem about a common axis. The cryocooler has a cold end and a hot end. The motor further includes multiple rigid thermal straps, a center ring mounted to one end of each of the rigid thermal straps, a cold end adapter mounted to the cold end of the cryocooler, and at least one flexible thermal strap mounted between the center ring and the cold end adapter.

According to one aspect of the invention, the motor includes multiple spokes extending between the outer shell of the rotor and the central shaft of the rotor to support the central shaft within the outer shell. Each of the spokes has a thermal conductivity less than 2 W/m. K.

According to still another aspect of the invention, the central shaft of the rotor includes openings spaced around a periphery of the central shaft. Each of the rigid thermal straps includes a first end mounted to the outer shell and a second end mounted to the center ring, and each of the rigid thermal straps extends through one of the openings in the periphery of the central shaft such that the center ring is suspended within the central shaft without being rigidly coupled to the central shaft. Each of the rigid thermal straps has a thermal conductivity of at least 300 W/m·K, and each coil is a high temperature superconducting (HTS) coil. The heat generated in the set of coils is conducted through the outer shell of the rotor to the rigid thermal straps, from the rigid thermal straps to the center ring, from the center ring to the at least one flexible thermal strap, from the at least one flexible thermal strap to the cold end adapter, and from the cold end adapter to the cold end of the cryocooler. Optionally, the motor may also include a rotor lead extending between each rotor coil and the center ring.

According to still other aspects of the invention, the motor includes a housing surrounding the rotor and a pump to evacuate air from within the housing to establish a vacuum within the housing. The cold end of the cryocooler is mounted within the housing surrounding the rotor and the hot end of the cryocooler is mounted outside the housing surrounding the rotor. The at least one flexible thermal strap is made of a plurality of strands of metal. Optionally, the cold end adapter may be integrally formed with the cold end of the cryocooler. According to still another option, a plurality of mechanical supports may extend between the cold end adapter and an interior surface of the central shaft.

According to another embodiment of the invention, a motor includes multiple HTS coils mounted on an outer shell of a rotor, multiple rigid thermal straps having a first end mounted to the outer shell of the rotor, and a center ring, where a second end of each of the rigid thermal straps is mounted to the center ring. A cryocooler is mounted within the rotor to cool the HTS coils, where the cryocooler includes a cold end and a hot end. A cold end adapter is mounted to the cold end of the cryocooler, and at least one flexible thermal strap is mounted between the center ring and the cold end adapter.

These particular objects and advantages may apply to only some embodiments falling within the claims and thus do not define the scope of the invention.

### BRIEF DESCRIPTION OF THE DRAWINGS

FIG. 1 is a simplified exploded view of the principal components of a motor constructed according to one embodiment of the present invention including a stator and a concentrically rotating wound-field rotor within a vacuum envelope;

FIG. 2 is a perspective view of a rotor shell providing improved coil mounting surfaces;

FIG. 3 is a vertical plane perspective cross-section of the motor of FIG. 1 showing a cooling impeller placed around the hot end of the cryocooler for improved cooling, with an inset showing the impeller in cross-section;

FIG. 4 is a vertical cross-section of the impeller system of FIG. 3 showing airflow and improved heat conduction through the addition of a heat pipe;

FIG. 5 is a fragmentary, front elevational view of the spoke system of the present invention showing a mounting system eliminating deflection of the spokes between their connection points at ferrules;

FIG. 6 is a sectional view of a single spoke in isolation showing a threaded tensioner and a ball terminator at opposite ends of the spoke and a varying spoke composition and dimension;

FIG. 7 is a fragmentary perspective view of the ball terminator of FIG. 6 as attached to the shell wall;

FIG. 8 is a partial sectional view of a rotor for the motor of FIG. 1 according to one embodiment of the invention;

FIG. 9 is a partial perspective view of a motor shaft with a cryocooler extending from one end of the motor shaft and rigid thermal straps extending through openings proximate the other end of the motor shaft;

FIG. 10 is a partial sectional view of the motor shaft and cryocooler of FIG. 9;

FIG. 11 is a partial perspective view of a cryocooler, rigid thermal straps, a center ring, flexible thermal straps, and a cold end adapter for mounting a cold end of the cryocooler;

FIG. 12 is a perspective view of the center ring, flexible thermal straps, and cold end adapter of FIG. 11;

FIG. 13 is a perspective view of a first side of the center ring of FIG. 12;

FIG. 14 is a perspective view of a second side of the center ring of FIG. 12;

FIG. 15 is a perspective view of a first side of the cold end adapter of FIG. 12;

FIG. 16 is a perspective view of a second side of the cold end adapter of FIG. 12;

FIG. 17 is a partial sectional view of another embodiment of the rotor including rotor leads extending between the center ring and rotor coils; and

FIG. 18 is a partial sectional view of another embodiment of the rotor including support rods connected to the cold end adapter

### DETAILED DESCRIPTION OF THE PREFERRED EMBODIMENT

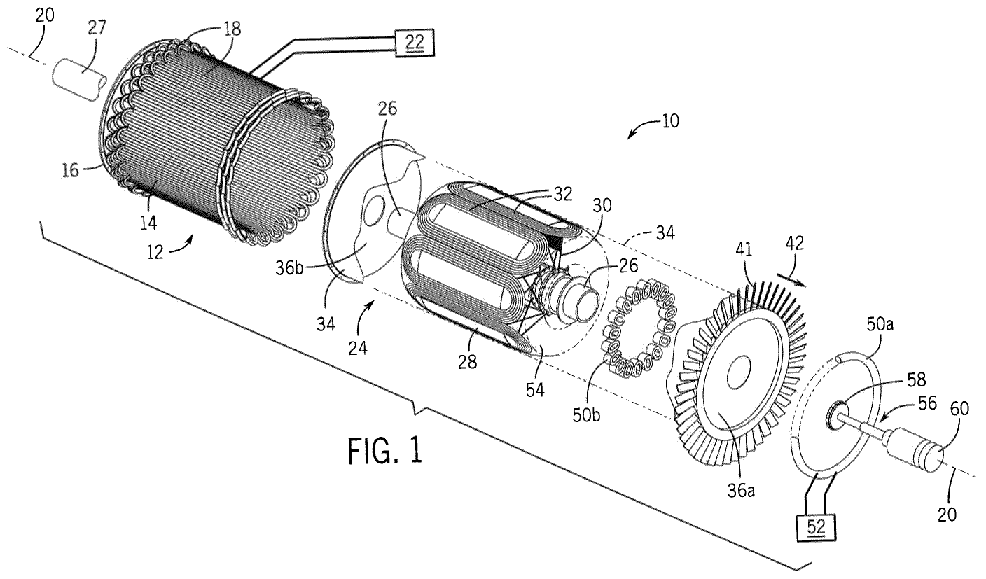

Referring now to FIG. 1, a superconducting motor 10 per the present invention may include a stator 12 providing, in one embodiment, a generally cylindrical, tubular stator form 14 having an outwardly flared end 16. A set of stator coils 18 may be attached to an inner surface of the stator form 14 spaced angularly about an axis 20 of the stator form 14 and extending between its opposite ends to provide a radially directed magnetic axis. The stator coils 18 may be air-core coils stabilized in a potting material as attached to the stator form 14 and may communicate with a motor drive circuit 22, for example, sequentially energizing the stator coils 18 to create a rotating magnetic field about the axis 20 as is generally understood in the art.

Fitting within the stator form 14 to rotate therein about the axis 20 is a rotor 24 providing a tubular rotor shaft 26 that may communicate beyond the confines of the motor 10 as a driveshaft 27 connected, for example, to turbine or propeller systems of aircraft or the like (not shown). The rotor shaft 26 may be supported for rotation on bearings generally understood in the art.

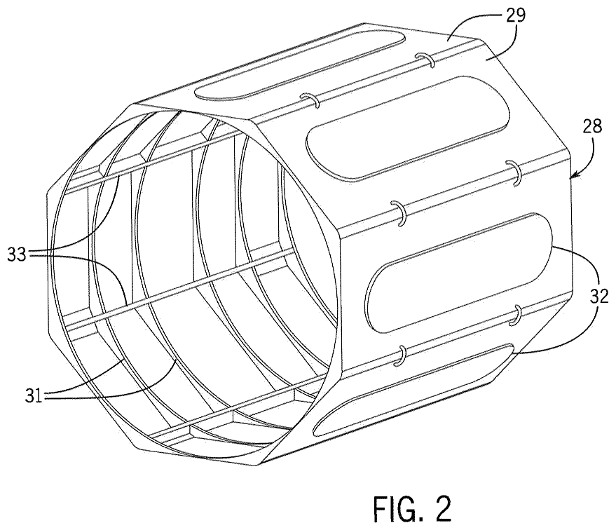

Referring also to FIG. 2, a rotor shell 28 is positioned concentrically around the shaft 26 and held for co-rotation with the shaft 26 by a set of thermally insulated spokes 30 radiating outwardly from the shaft 26 as will be discussed in more detail below. The rotor shell 28 may be a polygonal tube, for example, having an inner and outer circumference describing rotationally aligned regular polygons of cross-section, for example, with eight planar faces 29. The shell 28 may be constructed of faces 29 of aluminum or other lightweight material, to have low weight and low moment of inertia and will typically have a radial thickness of less than 100th of the radius of the shell 28 from the axis 20. A set of ribs 31 extending circumferentially in a ring about the axis 20 may have an outer polygonal periphery conforming to the polygonal shape of the inner surface of the rotor shell 28 and attached thereto, and an inner circular periphery providing good resistance to circumferential tension. The ribs may be spaced axially, for example, with a closer spacing toward the axially opposed ends of the shell 28 and may be joined by axially parallel stiffener struts 33.

An outer surface of the rotor shell 28 includes a set of rotor coils 32 having an elongate racetrack shape and, more specifically, following the shape of a geometric stadium being a rectangle with semicircles at opposite ends, with a longest dimension extending between axial ends of the rotor shell 28. The rotor coils 32 will be spaced circumferentially around the rotor shell 28 and centered within the faces 29 at equal angular intervals and may be air-core planar coils, the latter term, as used herein, meaning that the coils are substantially two-dimensional being wound helically in one or a limited number of layers to conform to a surface. Generally, the rotor coils 32 will be high-temperature superconductive (HTS) materials so as sustain a strong magnetic field without significant power consumption in the manner of a permanent magnet but with much lower mass and hence weight. Generally, the rotor coils 32 may be infused with a stabilizing polymer or epoxy material.

As so mounted, the rotor coils 28 may be substantially constrained to a single plane allowing bending of the conductors of the rotor coils but reduced twisting.

The stator coils 18 and rotor coils 32 may be integrated with sensors, for example, strain and temperature sensors, that may be wirelessly monitored, for example, to detect quenching or imminent failure. An electromagnetic shield, for example, of a conductive material such as copper or aluminum may surround the outer surface of the rotor coils 32, for example, as part of the vacuum shield to reduce losses caused by non-synchronous electromagnetic fields.

Referring again to FIG. 1, a cylindrical vacuum envelope 34 closely surrounds the rotor shell 28. A housing may include, for example, a cylindrical core on which the stator coils 18 are wound and end caps 36a and 36b providing bases to the cylinder and sealing the ends of the vacuum envelope 34 against the outer circumference of the shaft 26 to provide an airtight volume that may be evacuated to reduce convective heat loss between the rotor shell 28 and outside structures of the motor and between the rotor shell 28 and the shaft 26. End cap 36b may have a radially outwardly extending impeller 41 pulling air, as indicated by airflow 42, over the outer surface of the stator form 14 for cooling of the same as the rotor 24 rotates.

Positioned on either side of end cap 36a are wireless transmission coils 50a and 50b forming primary and secondary windings of a transformer for transferring power into the vacuum envelope 34 without breach thereof to provide excitation power to the rotor coils 32. The first wireless transmission coil 50a may be energized by a high-frequency power source 52, and the second wireless transmission coil 50b may communicate with the rotor coils 32 by means of a power conditioner 54 providing solid-state rectification and filtering of the alternating current transferred between the transmission coils 50a and 50b to produce the necessary DC voltages for the rotor coils 32. Other systems for wirelessly providing current to the coils 32 include contactless flux pumps of a type known in the art.

Referring now to FIGS. 1, 3, and 4, in one of multiple embodiments, a cryocooler 56 may extend along the axis 20 and have a cold end 58 passing into the hollow tubular shaft 26 to be roughly centered within the ends of the rotor 24 and attached to the shaft 26 by insulating supports to rotate therewith. A hot end 60 of the cryocooler 56 may extend outside of the vacuum envelope 34 and be fixed to a stationary structure so that rotation between the cold end 58 and hot end 60 may drive a sterling cycle heat pump pumping heat from the cold end 58 to the hot end 60 (at ambient temperatures) to bring the temperature of the cold end 58 to cryogenic temperatures of less than 50° Kelvin. According to one aspect of the invention, a mounting bracket 108 may be provided to position the cryocooler 56 within the motor shaft 26. Cryocoolers 56 suitable for use with the present invention are commercially available, for example, from the Sunpower Division of AMTEK of Berwyn, Pennsylvania, under the trade name CryoTel GT.

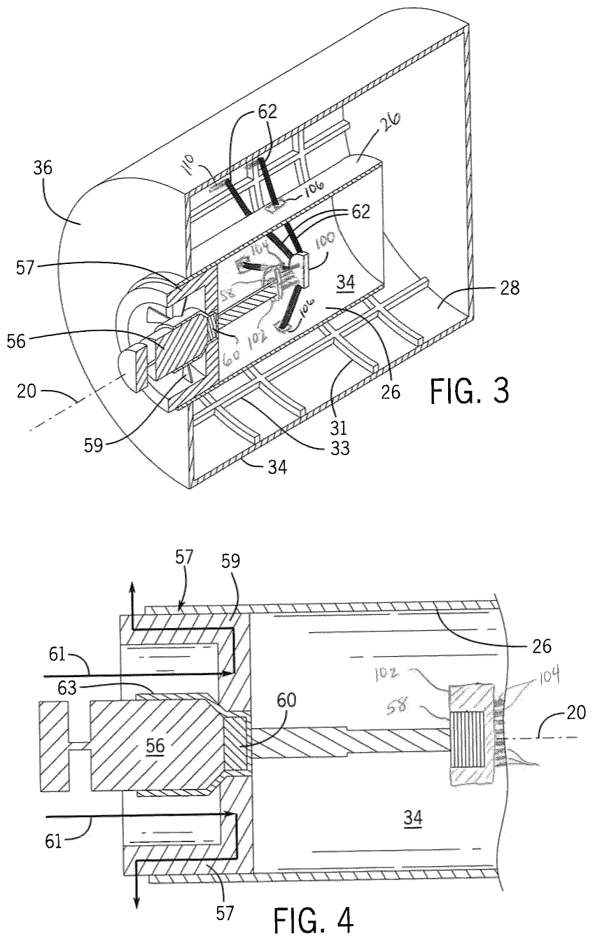

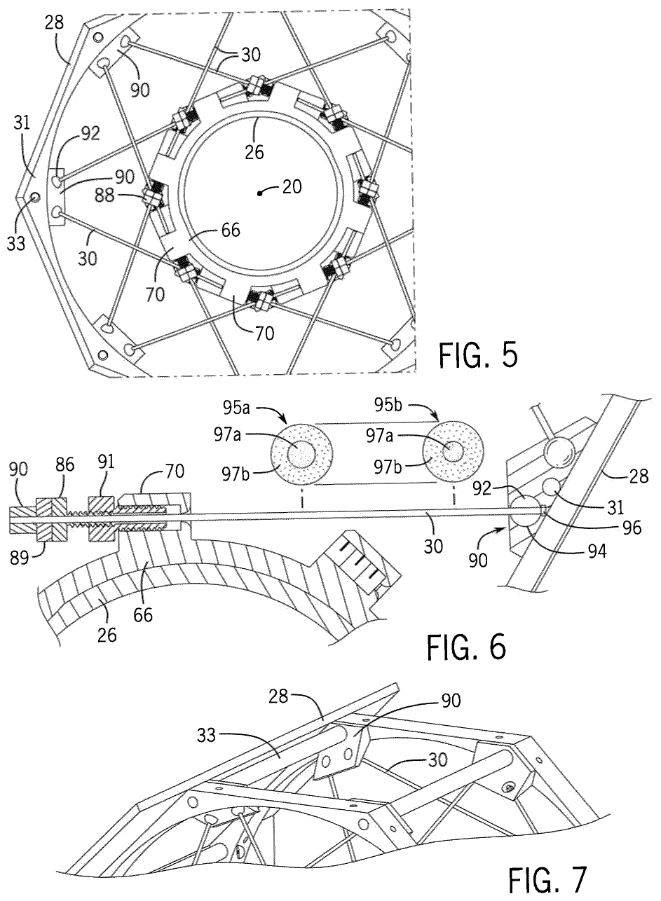

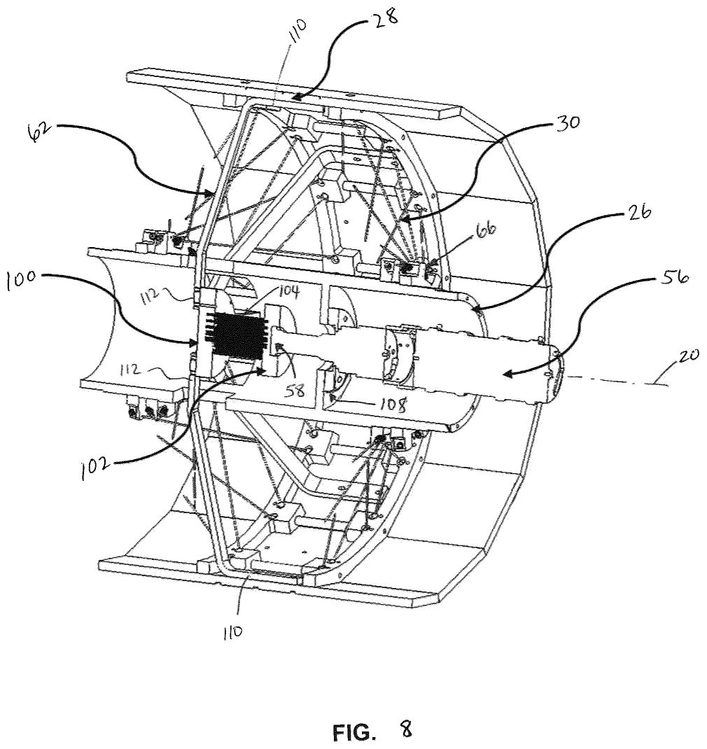

Referring now to FIGS. 3 and 8, a cooling mechanism is mounted to the cold end 58 of the cryocooler 56 to support the cryocooler within the shaft 26. Rigid thermally conductive straps 62 are spaced apart at equal angles around the axis 20 and extend radially between a center ring 100 and the rotor shell 28. Each rigid thermal strap 62 has an L-shaped first end 110, where the thermal strap extends in a generally radial direction from the interior of the shaft 26 toward the rotor shell 28 and the first end 110 extends in an axis generally parallel to the axis of rotation 20 and adjacent to the rotor shell 28 such that the first end 110 may be secured to the rotor shell 28. The rigid thermal straps 62 serve to draw heat from the rotor coils 32 toward the cold end 58 of the cryocooler 56. Generally, the rigid thermal straps 62 pass through openings 106 in the shaft 26 to be thermally insulated from the shaft.

The second end 112 of each rigid thermal strap 62 is configured to be mounted to a center ring 100 located within the shaft 26. The rigid thermal straps 62 are sufficiently rigid to support the center ring 100 at a fixed location aligned with the rotational axis 20 of the motor absent other supporting structure, allowing the center ring 100 to float, for example, with respect to the shaft 26. The cooling mechanism further includes a cold end adapter 102 mounted to the cold end 58 of the cryocooler 56 and flexible thermal straps 104 extending between the center ring 100 and the cold end adapter 102. Further details of the cooling mechanism are included below.

Referring now to FIGS. 1, 5 and 6, the spokes 30 may attach to spoke terminal rings 66 affixed to the rotor shaft 26 at opposite ends of the rotor 24 with the spokes 30 passing substantially tangentially from the rotor shaft 26 away from the axis 20 for maximum torsion resistance and reduced tensile forces. The spokes 30 are angled in opposite directions (clockwise and counterclockwise) away from axially extending and radially extending planes through the shaft 26 about the axis 20 and also extend inwardly toward the center of the rotor 24 along the axis away from radially extending planes normal to the axis 20 to provide resistance against axial motion between the shaft 26 and the shell 28 thereby reducing cooling load.

The spoke terminal ring 66 provides a set of radially protruding internally threaded sleeves 70 each having a bore axis angled such as to allow the spoke 30 to extend between the rotor shaft 26 and the shell 28 in a straight line eliminating kinks or bends that would concentrate shear stresses on the spokes 30 reducing their resistance to damage. The threaded sleeve 70 for each spoke 30 may receive an externally threaded tubular collar 86 having matching threads engaging the threaded sleeve 70 and a protruding end 88 having wrench flats 89 or the like. The spoke 30 passes through the tubular collar 86 and past the protruding end 88 where the spoke 30 has a formed or crimped on ferrule 96 larger than the opening in the tubular collar 86 and providing a first connection point to the rotor 26. In this way, a rotation of the tubular collar 86 may change the spacing between the opposing surface of the threaded sleeve 70 and the protruding end 88 thereby allowing adjustment of tension of the spoke 30. A lock nut 91 fitting around a threaded portion of the threaded tubular collar 86 may be tightened against the corresponding surface of the threaded sleeve 70 to lock the assembly against rotation and vibration.

The opposite end of the spoke 30 near the shell 28 may be received by a ball joint 90 providing for a spherical ball 92 fitting in a corresponding socket 94 to rotate therein. The spoke 30 may pass through a hole through the center of the ball 92 to be retained by a ferrule 96 or the like on its opposite side and providing a second connection point to the shell 28 such as resists its tensile forces. This ball joint 90 allows natural alignment of the ball 92 with the force on the spoke 30 again maintaining the spoke 30 in a straight configuration for reduced stresses even against dimensional changes in the structures holding the spoke 30 at cryogenic temperatures. The socket 94 may be attached to a rib 31 and be given additional support by struts 33.

The spokes 30 desirably provide balanced low thermal conduction, high tensile strength, and vibration damping and for this purpose may be constructed of a combination of different materials having different thermal conduction, tensile strength, and vibration damping including Kevlar™ (Poly (azanediyl-1,4-phenyleneazanediylterephthaloyl)), nylon, polyethylene, carbon fiber, glass fiber, metals or the like including materials generally having a Young's modulus of no less than substantially 70 GPa and a thermal conductivity of less than 2 W/mK or less than 0.5 W/m-k in some embodiments. Importantly, the spokes 30 should have a high-yield strength to thermal conductivity, for example, greater than 10,000,000

$$\frac{{σ}_{ys}}{k} ,$$

where σ_{ys} is measured in MPa and K as W/m/k.

Desirably at least two different fiber types 97a and 97b will be combined together in a composite spoke 30, the fiber types having different loss factors describing the conversion of vibration energy in the heat according to the hysteresis properties of its stress-strain properties. The selection of these materials is made to reduce the internally generated spoke-heat that is flowing into the rotor as much as possible, for example, two different types of tensile members may be used such as polymer fibers, such as Kevlar™, having higher loss factors combined with carbon fiber having lower loss factors. Other combinations of polymer and metal may be employed. The cross-sectional dimension, shown by cross-sections 95a and 95b of the spoke 30 may vary along the length of the spoke 30 by at least 5% as well as the composition of the spoke (by ratio change of at least 5%), for example, from different tensile fibers to be optimized for different points in the extreme temperature gradient along spokes 30. The combination of different filament types may be implemented by combining filaments in parallel at a filament level before braiding. Alternatively, braids of a given filament type may be created and then combined by additional braiding.

It is generally contemplated that the spokes 30 may be a blended material, possibly with inter-mingled fibers, uninterrupted in their communication between the rotor shell 28 and the rotor shaft 26; however it will be appreciated that a multi segment spoke 30 may also be used, for example, having different materials along its length, for example, a material with higher thermal conductivity interrupted by short intervals of thermally blocking material or the like, and thus that the bulk properties of the spokes 30 must be considered with respect to the limitations and designs described herein. The spokes 30 are generally flexible but provide rigid connection between the shaft 26 and shell 28 by means of tension which may be set to accommodate contraction of the shell 28 after assembly and cooling to cryogenic temperatures. Generally, the spokes 30 will be flexible, for example, and bend by more than 20° when held horizontally at one end and extend horizontally over distance of 1 m.

During manufacture, the spokes 30 may be preloaded statically to less than half of their yield stress so that they have capacity to resist torsion during use. This pre-tensioning is in part caused by the cool down of the rotor shell 28 which may be calculated and used for this purpose in determining the static tensioning.

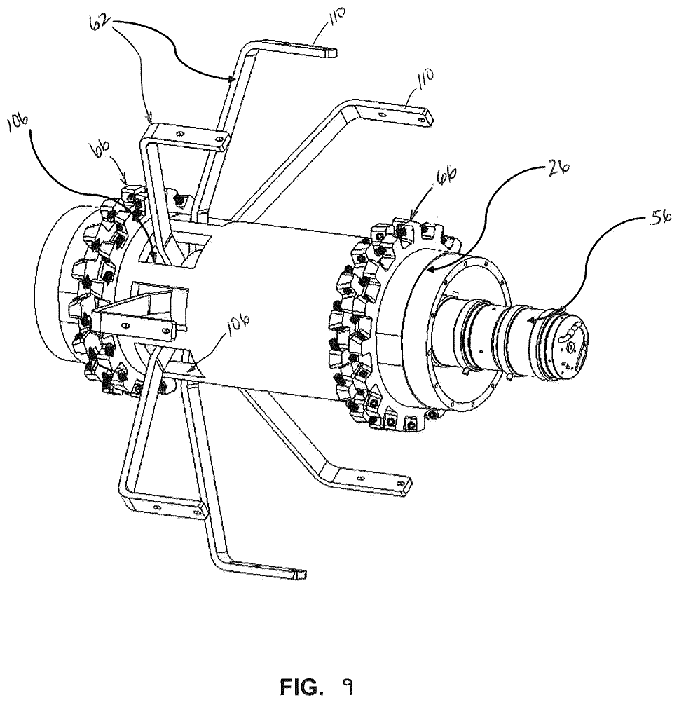

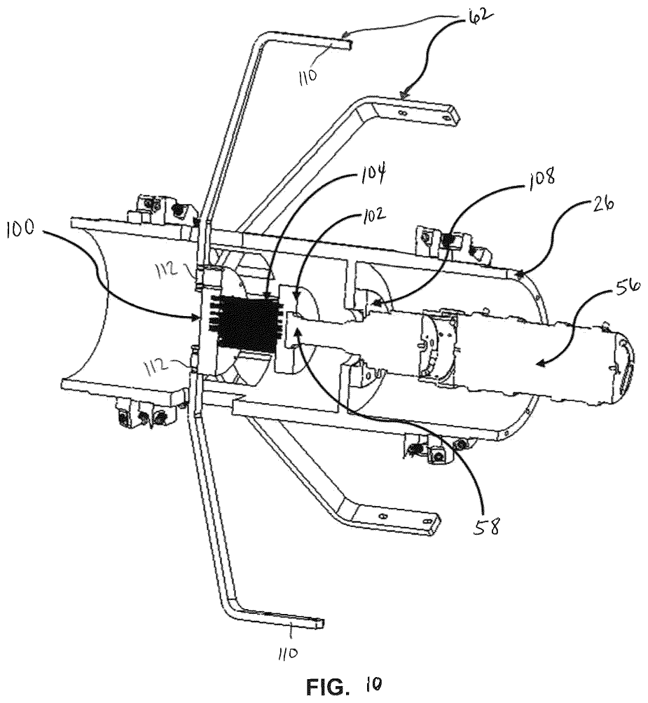

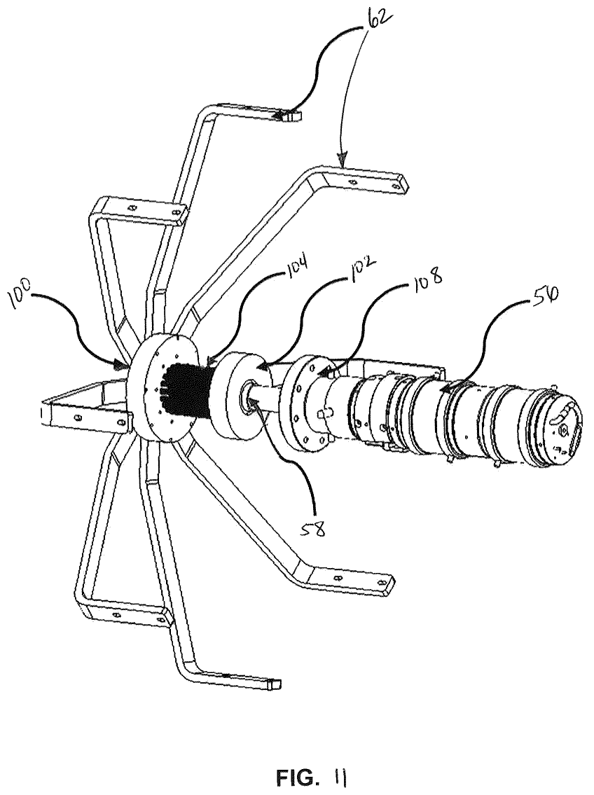

Turning next to FIGS. 8-11, one embodiment of the vibration tolerant cooling mechanism is illustrated. The cooling mechanism includes multiple rigid thermal straps 62, a center ring 100, a cold end adapter 102, and at least one flexible thermal strap 104 mounted between the center ring and the cold end adapter. As discussed above, a first end 110 of each rigid thermal strap 62 is mounted to the rotor shell 28. At least one rigid thermal strap 62 is mounted to an interior surface of each face 29 for the rotor shell 28, where a rotor coil 32 is mounted to the exterior surface of each face. The rotor coils 32 are configured to be HTS coils so as sustain a strong magnetic field without significant power consumption in the manner of a permanent magnet but with much lower mass and hence weight. Consequently, the rotor coils 32 need to be cooled to the required HTS cryogenic temperature, and the rigid thermal straps 62 provide the first link in a thermal conduction path between each rotor coil 32 and the cryocooler 56 mounted within the shaft 26 of the motor 10. Each rigid thermal strap 62 extends generally in a radial direction inward from the rotor shell 28 toward the axis of rotation 20 for the motor 10. Openings 106 are present in the shaft 26, allowing the rigid thermal straps 62 to pass through the outer surface and to the interior of the shaft 26.

A second end 112 of each rigid thermal strap 62 is mounted to a center ring 100 within the shaft 26. According to the illustrated embodiment (see also FIGS. 13 and 14), the center ring 100 has an annular outer periphery. The illustrated embodiment is not intended to be limiting. The center ring 100 may have an exterior periphery that is triangular, square, rectangular, or of any other polygonal shape. The illustrated embodiment further illustrates a generally solid mass with a set of recesses 120 configured to receive one end of a flexible thermal strap 104 and a set of openings 122 extending through the center ring 100 to receive a fastener (not shown) by which the second end 112 of each rigid thermal strap 62 is secured to the center ring 100. It is contemplated that a portion of the center ring 100 may have an additional opening such that the center ring 100 is not a solid mass. Further, other connectors may be provided on the center ring 100 by which the rigid thermal straps 62 and the flexible thermal straps 104 are secured thereto.

Each rigid thermal strap 62 is constructed from highly thermally conductive and structurally robust material such as copper or aluminum. According to one aspect of the invention, the material from which each rigid thermal strap is constructed has a thermal conductivity of at least 300 W/m·k. According to one aspect of the invention, each rigid thermal strap 62 has a cross-sectional area of at least 1 mm by 10 mm. The rigid thermal straps 62 are configured to be self-supported from the interior surface of the faces 29 of the rotor shell 28, ensuring that their weight does not transfer to the center ring 100 or to the cold end adapter 102.

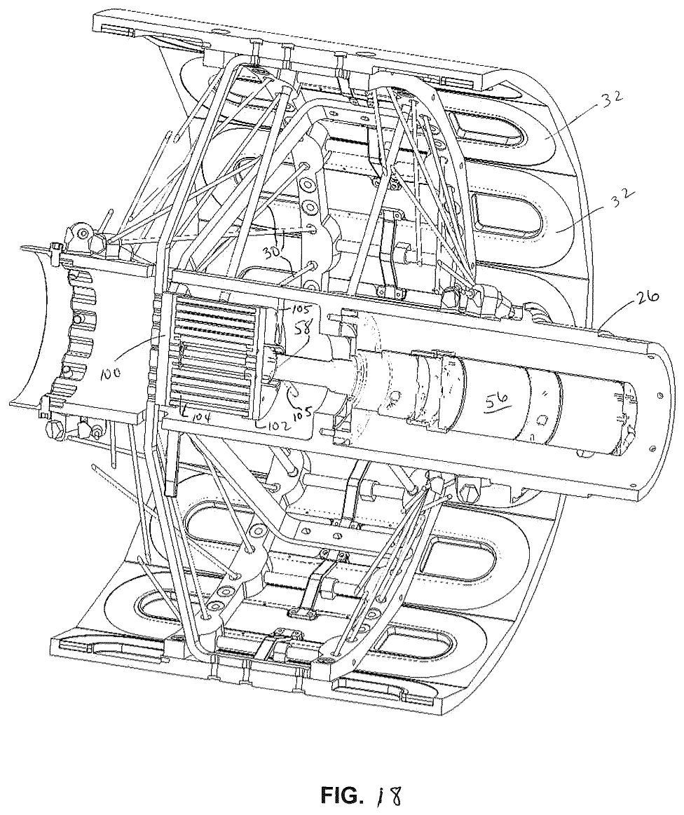

With reference next to FIG. 17, the motor 10 may include rotor leads 114 extending from the power conditioner 54 to the rotor coils 32 to further facilitate heat transfer from the coils 32 to the cold end 58 of the cryocooler 56. A rotor lead 114 is preferably made of copper and extends from the center ring 100 to the rotor coil 32. The rotor lead 114 may be routed along a rigid thermal strap 62, and an insulating layer 116 is positioned between the rotor lead 114 and the thermal strap 62. Optionally, the insulating layer 116 may surround the rotor lead 114 for at least a portion of the distance between the center ring 100 and the rotor coil 32. A portion of the heat generated in the rotor coil 32 may then be conducted directly from the coil 32 along the rotor lead 114 back toward the center ring 100. Another portion of the heat generated in the rotor coil 32 is conducted through the face 29 of the rotor shell 28 to the thermal strap 62 and, in turn, to the center ring 100. This dual conduction path increases the rate at which heat may be drawn from the rotor coil 32 to the cryocooler 56.

The center ring 100 is supported by the rigid thermal straps 62 and floats centrally within the shaft 26 such that the weight of the center ring 100 is supported from the interior surface of the faces 29 of the rotor shell 28 and not transferred to the cold end adapter 102. The center ring 100 provides a connection point for each of the rigid thermal straps 62 to provide balance and cancel out centrifugal forces during operation. The center ring 100 is also constructed from highly thermally conductive and structurally robust material such as copper or aluminum. According to one aspect of the invention, the material from which each center ring 100 is constructed has a thermal conductivity of at least 300 W/m·k. The center ring 100 provides a second link in the thermal conduction path between each rotor coil 32 and the cryocooler 56 mounted within the shaft 26 of the motor 10.

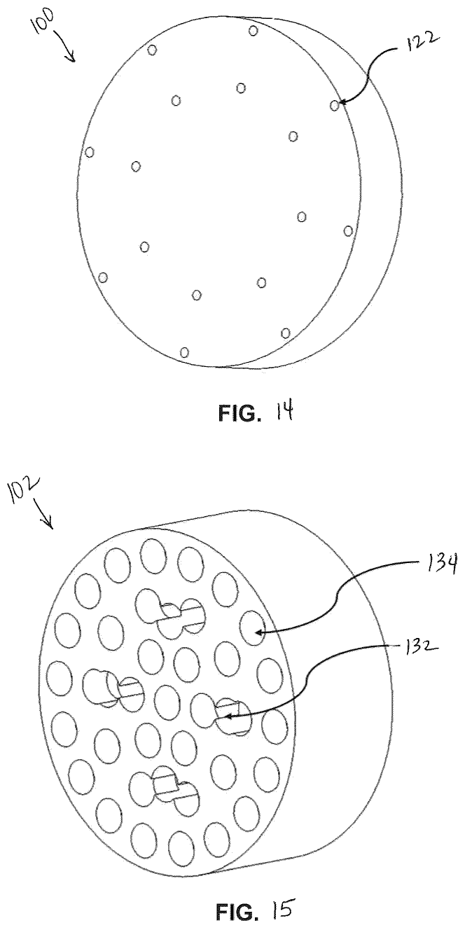

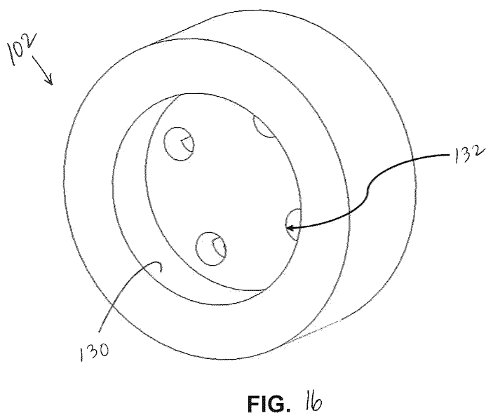

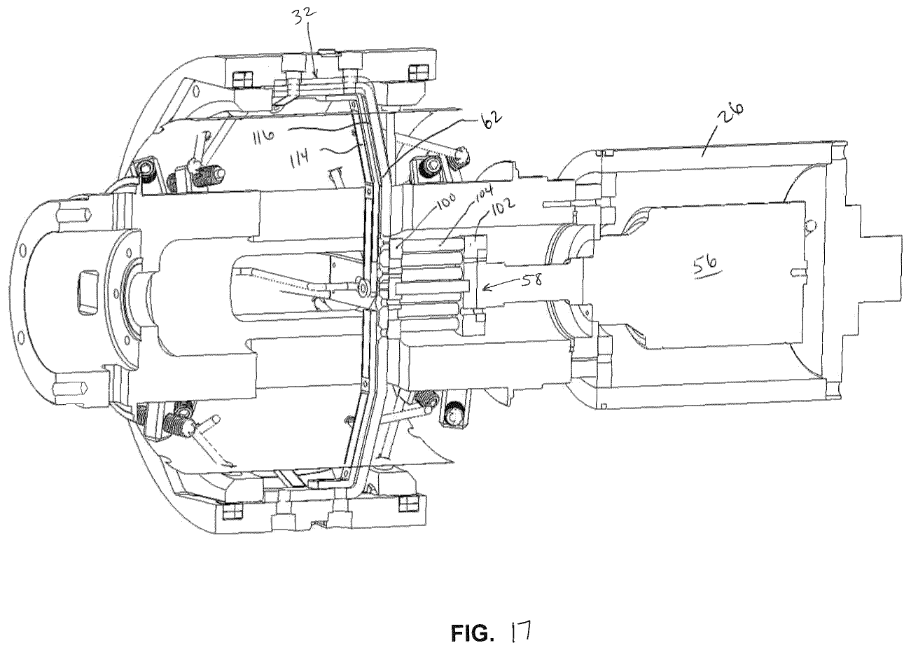

With reference next to FIGS. 15 and 16, the illustrated embodiment of the vibration tolerant cooling mechanism includes a cold end adapter 102 for mounting to the cold end 58 of the cryocooler 56. The cold end adapter 102 includes a chamber 130 on one side of the adapter to receive the cold end 58. A series of openings 132 extend through the cold end adapter 102 to receive a fastener (not shown) by which the cold end adapter 102 is secured to the cold end of the cryocooler 56. The other side of the cold end adapter 102 includes recesses 134 configured to receive one end of a flexible thermal strap 104. The cold end adapter 102 is the final link in the thermal conduction path between each rotor coil 32 and the cryocooler 56 mounted within the shaft 26 of the motor 10. The cold end adapter 102 is constructed from highly thermally conductive materials like copper and has a thermal conductivity of at least 300 W/m·k. The weight of the cold end adapter 102 is supported by the cryocooler 56 and, in turn, the mounting bracket 108 provided to position the cryocooler 56 within the motor shaft 26. The illustrated embodiment is not intended to be limiting. According to another aspect of the invention the cold end 58 of the cryocooler 56 may be configured to directly receive the flexible thermal straps 104 and a cold end adapter 102 may not be required and/or integrally formed with the cold end 58 to provide the recesses 134 for the flexible thermal straps 104.

With reference also to FIG. 18, mechanical supports 105 may be provided to support the cold end of the cryocooler 56. The mechanical supports 105 are preferably nonconductive and able to withstand the temperatures required for high temperature superconductivity. According to one aspect of the invention, the mechanical supports are made of a woven fiberglass material, where the woven fiberglass includes an epoxy resin binder. An exemplary mechanical support 105 may be made of G-10 rods. The mechanical supports 105 may be connected to one side of the cold end adapter 102. Optionally, the mechanical supports 105 may be mounted to the cold end 58 of the cryocooler 56. With mechanical supports 105, the weight of the cold end adapter 102 is supported by the mechanical supports 105 further reducing strain applied to the cold end 58 of the cryocooler 56.

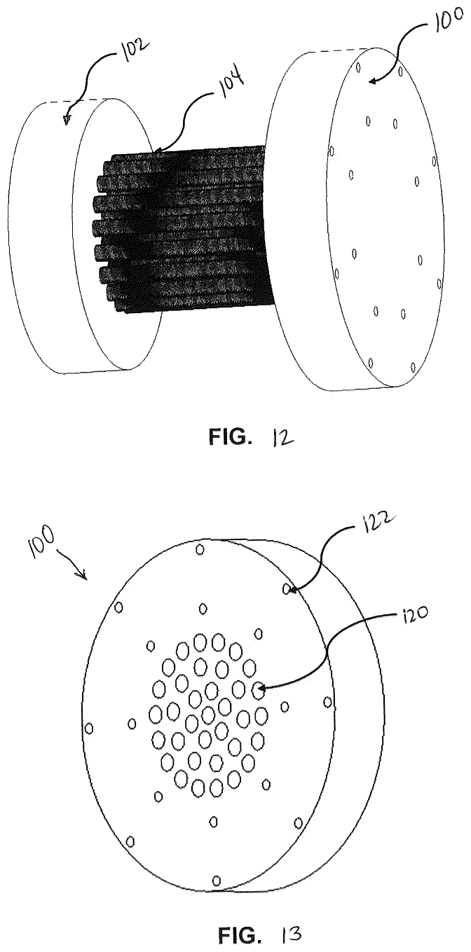

Turning next to FIG. 12, flexible thermal straps 104 are provided between the center ring 100 and the cold end adapter 102. At least one flexible thermal strap 104 is provided. According to the illustrated embodiment, multiple flexible thermal straps 104 are provided, where a first end of each flexible thermal strap 104 is mounted within a recess 120 on the center ring 100, and a second end of each flexible thermal strap is mounted within a recess 134 of the cold end adapter 102. The flexible thermal straps 104 are made with flexible materials to provide flexibility in alignment between the center ring 100 and the cold end adapter 102. They effectively isolate the cold end 58 from the rotor, preventing vibration and imbalance forces from being transferred to the cold end. Moreover, any axial misalignment between the center ring 100 and the cold end 58 due, for example, by mounting and/or variation in manufacturing of the rigid thermal straps is accounted by the flexibility of the flexible thermal straps 104. The flexible thermal straps 104 are not subject to torque because the cryocooler 56 rotates with the shaft 26 and the center ring 100 rotates with the rotor shell 28, where the rotor shell 28 is suspended on the shaft 26 via the spokes 30 discussed above.

The flexible thermal straps 104 are also made with highly thermally conductive flexible materials such as copper or aluminum strands. According to one aspect of the invention, the material from which each flexible thermal strap 104 is constructed has a thermal conductivity of at least 300 W/m·k. The flexible thermal straps 104 are connected between the center ring 100 and the cold end adapter 102 to provide the third link in the thermal conduction path between each rotor coil 32 and the cryocooler 56 mounted within the shaft 26 of the motor 10. According to one aspect of the invention, the flexible thermal straps 104 are mounted by soldering or welding the straps to the cold end adapter 102 and the center ring 100. The center ring 100, flexible thermal straps 104 and cold end adapter 102 may be joined together prior to insertion within the motor 10, forming a single part for assembly.

In operation, the cryocooler 56 operates to bring the rotor coils 32 down to cryogenic temperatures of less than 50° Kelvin suitable for providing superconductivity in the coils 32, or temperatures of less than 77° Kelvin suitable for high temperature superconductivity. With reference again to FIGS. 3 and 4, the hot end 60 of the cryocooler 56 extends outside of the vacuum envelope 34 and may be encircled by an impeller 57 attached to rotate with the shaft 26 and thus with respect to the hot end 60 to draw cooling air 61 past the hot end 60 during operation of the motor 10. The impeller 57 may have a set of radially extending blades 59 centrifugally driving air radially outwardly after having passed by the hot end 60 outside of the vacuum envelope and end cap 36. A heat pipe 63 may extend out from the hot end 60 into the path of cooling air 61 to improve heat transfer given the axial displacement of the impeller 57. The cryocooler operates to transfer heat from the cold end 58 to the hot end 60 of the cryocooler. The temperature of the cold end 58 creates a temperature gradient along the thermal conduction path between the rotor coils 32 and the cold end 58 such that heat generated in the set of coils 32 is conducted through the outer shell 28 of the rotor to the rigid thermal straps 62, from the rigid thermal straps 62 to the center ring 100, from the center ring 100 to the at least one flexible thermal strap 104, from the at least one flexible thermal strap 104 to the cold end adapter 102, and from the cold end adapter 102 to the cold end 58 of the cryocooler 56.

The heavier components of the cooling system, such as the rigid thermal straps 62 and the center ring 100 are mounted to the rotor shell 28 which is, in turn, supported by the shaft 26 via the spokes 30. The cryocooler 56 and the cold end adapter 102 are similarly supported by the shaft 26 via the mounting bracket 108. Thus, each of the components of the cooling mechanism is independently supported by the shaft 26 to isolate forces and vibrations from other components. The center ring 100 cancels out the centrifugal forces acting on the rigid thermal straps 62, preventing them from transferring to the rotor shell 28 during operation.

In addition, while the above description is generally focused on the construction of a motor, it will be appreciated that the same principles will produce an electrical generator and thus the invention generally involves an electrical machine rather than a motor or generator particularly.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112 (f) unless the words “means for” or “step for” are explicitly used in the particular claim.

What we claim is:

1. A motor, comprising:
a stator; and
a rotor, comprising:
an outer shell;
a central shaft mounted within the outer shell, wherein the outer shell and the central shaft rotate in tandem about a common axis;
a set of coils mounted on the outer shell;
a cryocooler mounted within the central shaft, wherein the cryocooler has a cold end and a hot end;
a plurality of rigid thermal straps;
a center ring mounted to one end of each of the plurality of rigid thermal straps;
a cold end adapter mounted to the cold end of the cryocooler; and
at least one flexible thermal strap mounted between the center ring and the cold end adapter.

2. The motor of claim 1, further comprising a plurality of spokes extending between the outer shell of the rotor and the central shaft of the rotor to support the central shaft within the outer shell.

3. The motor of claim 2, wherein each of the plurality of spokes has a thermal conductivity less than 2 W/mK.

4. The motor of claim 2, wherein:
the central shaft includes a plurality of openings spaced around a periphery of the central shaft;
each of the plurality of rigid thermal straps includes a first end mounted to the outer shell and a second end mounted to the center ring; and
each of the plurality of rigid thermal straps extends through one of the plurality of openings in the periphery of the central shaft such that the center ring is suspended within the central shaft without being rigidly coupled to the central shaft.

5. The motor of claim 4, wherein each coil of the set of coils is a high temperature superconducting (HTS) coil.

6. The motor of claim 5, wherein heat generated in the set of coils is conducted through the outer shell of the rotor to the plurality of rigid thermal straps, from the plurality of rigid thermal straps to the center ring, from the center ring to the at least one flexible thermal strap, from the at least one flexible thermal strap to the cold end adapter, and from the cold end adapter to the cold end of the cryocooler.

7. The motor of claim 5 further comprising a rotor lead extending between each coil of the set of coils and the center ring.

8. The motor of claim 1, further comprising:
a housing surrounding the rotor; and
a pump to evacuate air from within the housing to establish a vacuum within the housing.

9. The motor of claim 8, wherein the cold end of the cryocooler is mounted within the housing surrounding the rotor and the hot end of the cryocooler is mounted outside the housing surrounding the rotor.

10. The motor of claim 9, wherein:
each coil of the set of coils is a high temperature superconducting (HTS) coil; and
heat generated in the set of coils is conducted through the outer shell of the rotor to the plurality of rigid thermal straps, from the plurality of rigid thermal straps to the center ring, from the center ring to the at least one flexible thermal strap, from the at least one flexible thermal strap to the cold end adapter, and from the cold end adapter to the cold end of the cryocooler.

11. The motor of claim 1, wherein the at least one flexible thermal strap is made of a plurality of strands of metal.

12. The motor of claim 1, wherein the cold end adapter is integrally formed with the cold end of the cryocooler.

13. The motor of claim 1, further comprising a plurality of mechanical supports extending between the cold end adapter and an interior surface of the central shaft.

14. A motor, comprising:
a plurality of high temperature superconducting (HTS) coils mounted on an outer shell of a rotor;
a plurality of rigid thermal straps having a first end mounted to the outer shell of the rotor;
a center ring, wherein a second end of each of the plurality of rigid thermal straps is mounted to the center ring;
a cryocooler mounted within the rotor to cool the HTS coils, wherein the cryocooler includes a cold end and a hot end;
a cold end adapter mounted to the cold end of the cryocooler; and
at least one flexible thermal strap mounted between the center ring and the cold end adapter.

15. The motor of claim 14, further comprising a rotor lead extending between each of the plurality of HTS coil and the center ring.

16. The motor of claim 14, wherein the at least one flexible thermal strap is made of a plurality of strands of metal.

17. The motor of claim 14, wherein the cold end adapter is integrally formed with the cold end of the cryocooler.

18. The motor of claim 14, further comprising:
a housing surrounding a rotor of the motor; and
a pump to evacuate air from within the housing to establish a vacuum within the housing.

19. The motor of claim 14, further comprising:
a rotor shell;
a central rotor shaft mounted within the rotor shell, wherein the rotor shell and the central rotor shaft rotate in tandem about a common axis; and
a plurality of spokes extending between the rotor shell and the central rotor shaft to support the central rotor shaft within the rotor shell.

20. The motor of claim 19, further comprising a plurality of mechanical supports extending between the cold end adapter and an interior surface of the central rotor shaft.
